(19) United States
(12) Patent Application Publication
(10) Pub. No.: US 2005/0144427 A1
(43) Pub. Date: Jun. 30, 2005

(54) Processor including branch prediction mechanism for far jump and far call instructions

(75) Inventors: Gerard M. Col, Austin, TX (US); Thomas C. McDonald, Austin, TX (US)

Correspondence Address: HUFFMAN LAW GROUP, P.C., 1832 N. CASCADE AVE., COLORADO SPRINGS, CO, 80907-7449, US

(73) Assignee: IP-First LLC, Freemont, CA (US)

(21) Appl. No.: 10/279,205

(22) Filed: Oct. 22, 2002

Related U.S. Application Data
(60) Provisional application No. 60/345,453, filed on Oct. 23, 2001.

(51) Int. Cl. G06F 9/30

(52) U.S. Cl. 712/242

(57) ABSTRACT

A method and apparatus are provided for processing far jump-call branch instructions to increase the efficiency of a processor pipeline. The processor includes a far jump-call target buffer which stores the default address/operand size corresponding to each of a plurality of previously executed far jump-call instructions. When a far jump-call instruction is encountered, it is speculatively executed using the corresponding default address/operand size for that instruction as stored in the far jump-call target buffer. This speculative far jump-call instruction is executed and resolved thus determining the actual address/operand size. If the actual address/operand size matches the speculative default address/operand size then the speculation was correct and processing continues. However, if there is no match, then the speculation was wrong and the pipeline is flushed.

### CROSS-REFERENCE TO RELATED APPLICATIONS

This application claims priority based on U.S. Provisional Application Ser. No. 60/345,453, filed Oct. 23, 2001, entitled BRANCH PREDICTION FOR FAR JUMPS THAT INCLUDES DEFAULT OPERATION SIZE.

This application is related to U.S. patent application Ser. No. ______ (Docket CNTR.2019) entitled “PROCESSOR INCLUDING FALLBACK BRANCH PREDICTION MECHANISM FOR FAR JUMP AND FAR CALL INSTRUCTIONS,” by Gerard M. Col and Thomas C. McDonald, and filed on the same date as the present application, the disclosure thereof being incorporated herein by reference.

### BACKGROUND OF THE INVENTION

1. Field of the Invention

This invention relates in general to the field of microprocessors, and more particularly to a method and apparatus for performing branch prediction on far jump and far call instructions.

2. Description of the Related Art

In information handling systems computer instructions are typically stored in successive addressable locations within a memory. When processed by a Central Processing Unit (CPU), the instructions are fetched from these consecutive memory locations and executed. Each time an instruction is fetched from memory, a program counter within the CPU is incremented so that it contains the address of the next instruction in the sequence. Fetching of an instruction, incrementing of the program counter, and execution of the instruction continue linearly through memory until a program control instruction such as a jump-on-condition, a non-conditional jump, or a call instruction is encountered.

A program control instruction, when executed, changes the address in the program counter and causes the flow of control to be altered. In other words, program control instructions specify conditions for altering the contents of the program counter. The change in the value of the program counter as a result of the execution of a program control instruction causes a break in the otherwise successive sequence of instruction execution. This is an important feature in digital computers since it provides for programmable control over the flow of instruction execution and a capability for branching to different portions of a program.

A non-conditional jump instruction causes the CPU to unconditionally change the contents of the program counter to a specific value, i.e., to the target address for the instruction where the program is to continue execution. A Test-and-Jump instruction, or Conditional Jump instruction, conditionally causes the CPU to test the contents of a status register, or possibly compare two values, and either continue sequential execution or jump to a new address, called the target address, based on the outcome of the test or comparison. A Call instruction causes the CPU to unconditionally jump to a new target address and also saves the value of the program counter to allow the CPU to return to the program location it is leaving. A Return instruction causes the CPU to retrieve the value of the program counter that was saved by the last Call instruction, and return program flow back to the retrieved instruction address.

In early microprocessors, execution of program control instructions did not impose significant processing delays because such microprocessors were designed to execute only one instruction at a time. Consequently, no penalties were incurred if the instruction being executed was a program control instruction, regardless of whether execution of the instruction determined if it should branch or not. Since only one instruction was capable of being executed, the same delays were experienced by both sequential and branch instructions.

However, modern microprocessors are not so simple. Rather, it is common for modern microprocessors to operate on several instructions at the same time, within different blocks or pipeline stages of the microprocessor. Hennessy and Patterson define pipelining as, “an implementation technique whereby multiple instructions are overlapped in execution.” Computer Architecture: A Quantitative Approach, second edition, by John L. Hennessy and David A. Patterson, Morgan Kaufmann Publishers, San Francisco, Calif., 1996. The authors go on to provide the following excellent illustration of pipelining: “A pipeline is like an assembly line. In an automobile assembly line, there are many steps, each contributing something to the construction of the car. Each step operates in parallel with the other steps, though on a different car. In a computer pipeline, each step in the pipeline completes a part of an instruction. Like the assembly line, different steps are completing different parts of the different instructions in parallel. Each of these steps is called a pipe stage or a pipe segment. The stages are connected one to the next to form a pipe-instructions enter at one end, progress through the stages, and exit at the other end, just as cars would in an assembly line.”

Thus, in a present day microprocessor, instructions are fetched into one end of the pipeline, and then they proceed through successive pipeline stages until they complete execution. In such pipelined microprocessors it is not known whether a branch instruction will alter program flow until the instruction reaches a late stage in the pipeline. But to stall fetching of instructions while allowing the branch instruction to proceed through the pipeline until it is determined whether or not program flow is altered is inefficient.

To alleviate this problem, many pipelined microprocessors use branch prediction mechanisms in an early stage of the pipeline that predict the outcome of branch instructions, and then fetch subsequent instructions according to the branch prediction. If the branch prediction is correct, then the aforementioned inefficiency is overcome. If the branch prediction is incorrect, then the pipeline must be flushed of those instructions resulting from the incorrect branch prediction and refilled with instructions associated with the correct outcome of the branch.

There are two kinds of jump instructions: near jump instructions branch to an address within the same data segment; far jump instructions branch to an address in a different data segment. Similarly, near call instructions branch to an address within the same data segment, and far call instructions branch to an address in a different data segment.

In earlier X86 pipeline microprocessors, the pipeline was stalled whenever a far jump or far call instruction is executed until the instruction proceeds through the pipeline to the point that its target address is computed. This is because computation of a target address for a far jump or far call instruction requires that a new code segment descriptor be loaded into the code segment descriptor register of the microprocessor. (The term “far jump/call” is used collectively herein to indicate a far jump or far call instruction.) The far jump/call instruction prescribes a new code segment selector along with an offset. The code segment selector designates the new code segment descriptor. The new code segment descriptor includes a new code segment base address to which the offset is added to determine the far jump/call target address. Once this target address has been computed, it is provided to the NSIP so that subsequent instructions beginning at the target address can be fetched and executed.

In addition to specifying the new code segment base address, a code segment descriptor specifies a default length (i.e. address mode) for all effective addresses and operands (i.e. operand mode) referenced by instructions within the respective code segment. More particularly, in an x86-compatible microprocessor, the default length, or operation size, is specified in a bit of the segment descriptor known as the D bit. If the D bit is set, then default 32-bit addresses/operands are prescribed, whereas if the D bit is not set, then default 16-bit addresses/operands are prescribed.

As briefly referenced earlier, a disadvantage of prior microprocessor technology is that the pipeline is stalled to allow for computation of the target address corresponding to a far jump/call instruction. Unfortunately, the execution of all far jumps/calls incurs a penalty that is roughly equivalent to the number of stages in the pipeline between the stage where a far jump/call instruction is fetched and the stage where it is executed.

Earlier X86-compatible microprocessors did not perform any type of speculative branch prediction for far jumps/calls. More recent x86-compatible microprocessors do perform speculative branches for far jumps/calls, but the scope of the associated branch predictions is prescribed simply in terms of a branch target address; it is assumed that the state of the D bit does not change.

The present inventors have observed that many application programs employ far jump/call instructions to change default size of addresses/operands (i.e., the state of the D bit) used for subsequent instructions within a program flow. Yet when such instructions are executed according to present day far jump/call prediction techniques, the result is that the pipeline must be flushed when the new default address/operand size is determined (i.e., when the state of the D bit is accessed from the specified segment descriptor) because pipeline stage logic operating on instructions in preceding pipeline stages—albeit the instructions have been fetched from the correct target address—has performed address/operand calculations using the wrong default address/operand size.

Therefore, what is needed is a technique for performing branch prediction on far jumps and far calls in a manner which reduces the pipeline flushing penalties associated with far jumps and calls.

### SUMMARY OF THE INVENTION

In accordance with one embodiment of the present invention, a microprocessor is provided for processing instructions and for speculatively executing a plurality of far jump-call instructions. The microprocessor includes a memory for storing instructions and a far jump-call target buffer for storing a default address/operand size corresponding to each of a plurality of previously executed far jump-call instructions. The microprocessor also includes instruction fetch logic, coupled to the memory and the far jump-call target buffer, for fetching a far jump-call instruction from the memory thus providing a fetched far jump-call instruction. The far jump-call target buffer provides the pipeline with a default address/operand size corresponding to the fetched far jump-call instruction, thus providing a speculative default address/operand size.

In accordance with another embodiment of the present invention, a method is provided for speculatively executing a plurality of far jump-call instructions in a microprocessor including a pipeline for processing instructions. The method includes storing, in a far jump-call target buffer, a default address/operand size corresponding to each of a plurality of previously executed far jump/call instructions. The method also includes fetching a far jump-call instruction from an instruction memory thus providing a fetched far jump-call instruction. The method further includes retrieving, from the far jump-call target buffer, a default address/operand size corresponding to the fetched far jump-call instruction, thus providing a speculative default address/operand size. The method still further includes speculatively executing the fetched far jump-call instruction employing the speculative default address/operand size. The method also includes propagating the fetched far jump-call instruction through the pipeline until the fetched far jump-call instruction is executed and resolved to provide an actual address/operand size. The method further includes comparing the actual address/operand size with the speculative default address/operand size, and flushing the pipeline if the actual address/operand size is not the same as the speculative default address/operand size. The method still further includes continuing to process instructions without flushing the pipeline if the actual address/operand size is the same as the speculative default address/operand size.

Other features and advantages of the present invention will become apparent upon study of the remaining portions of the specification and drawings.

### BRIEF DESCRIPTION OF THE DRAWINGS

These and other objects, features, and advantages of the present invention will become better understood with regard to the following description, and accompanying drawings where:

FIG. 1 is a block diagram of the pipeline stages of a conventional microprocessor;

FIG. 2 is a block diagram of the disclosed microprocessor; and

FIG. 3 is a flow chart depicting the operation of far jump resolution logic in the pipeline of the disclosed microprocessor.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

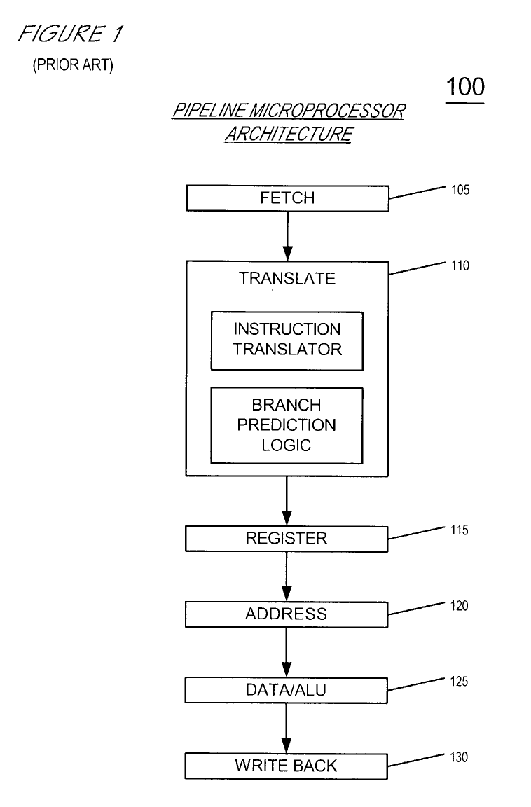

FIG. 1 is a block diagram of a related art pipelined microprocessor 100 which employs conventional branch prediction technology. Microprocessor 100 includes a fetch stage 105, a translate stage 110, a register stage 115, an address stage 120, a data/ALU stage 125, and a write back stage 130.

Operationally, fetch stage 105 fetches macro instructions from memory (not shown) that are to be executed by microprocessor 100. Translate stage 110 translates the fetched macro instructions into associated micro instructions.

Each micro instruction directs microprocessor 100 to perform a specific subtask related to accomplishment of an overall operation specified by a fetched macro instruction. Register stage 115 retrieves operands specified by the micro instructions from a register file (not shown) for use by later stages in the pipeline. Address stage 120 calculates memory addresses specified by the micro instructions to be used in data storage and retrieval operations. Data/ALU stage 125 either performs arithmetic logic unit (ALU) operations on data retrieved from the register file, or reads/writes data from/to memory using the memory address calculated in address stage 120. Write back stage 130 writes the result of a data read operation, or an ALU operation, to the register file. Thus, to review, macro instructions are fetched by fetch stage 105 and are translated into micro instructions by translate stage 110. The translated micro instructions proceed through stages 115-130 for execution. Pipeline operation is thus provided by microprocessor 100.

Translate stage 110 employs conventional branch prediction to increase the efficiency of the pipeline as discussed earlier. A significant disadvantage of this conventional microprocessor technology is that the pipeline is flushed whenever the execution logic determines a default address/operand size from accessing a new segment descriptor, although instructions in preceding pipeline stages have been properly fetched according to a correctly predicted target address.

Current x86 pipelined microprocessors are known to handle far jump/call instructions by either 1) not performing any type of speculative branch prediction or 2) performing speculative branches which are prescribed simply in terms of a branch target address. For example, the target address taken the last time the branch was taken is recorded in a conventional branch target buffer. The inventors of the technology disclosed herein have recognized that, particularly with regard to legacy code, many far jumps and far calls are executed merely to change address/operand mode (i.e. instruction length), for example from 16 bit to 32 bit and vice versa. In the absence of far jump branch prediction, a penalty is incurred each time a far jump/call is executed. With conventional branch prediction techniques it is highly likely that a greater penalty is incurred when a far jump/call is resolved and it is found that the state of the D bit has changed.

To overcome these limitations, the microprocessor according to the present invention includes a dedicated far branch target buffer BTB which stores not only branch target addresses but also default address/operation sizes for far jump/call instructions that have been fetched from memory. In the particular embodiment discussed subsequently, the far branch target buffer is a BTB dedicated to far branch instructions. It should be appreciated that a far branch target buffer can be integrated with a near branch target buffer within the spirit of this disclosure. When a far jump/call is encountered by the disclosed microprocessor, a corresponding speculative code segment base, speculative offset, and speculative D bit are provided by the far branch target buffer. The speculative code segment base, speculative offset, and speculative D bit may also be referred to as the predicted code segment base, predicted offset, and predicted D bit, respectively. The code segment base and offset are provided to fetch logic so that subsequent instructions can be speculatively fetched from the resulting speculative jump target address. The D bit is provided to subsequent pipeline stages for the processing of effective addresses and operands associated with the subsequent instructions.

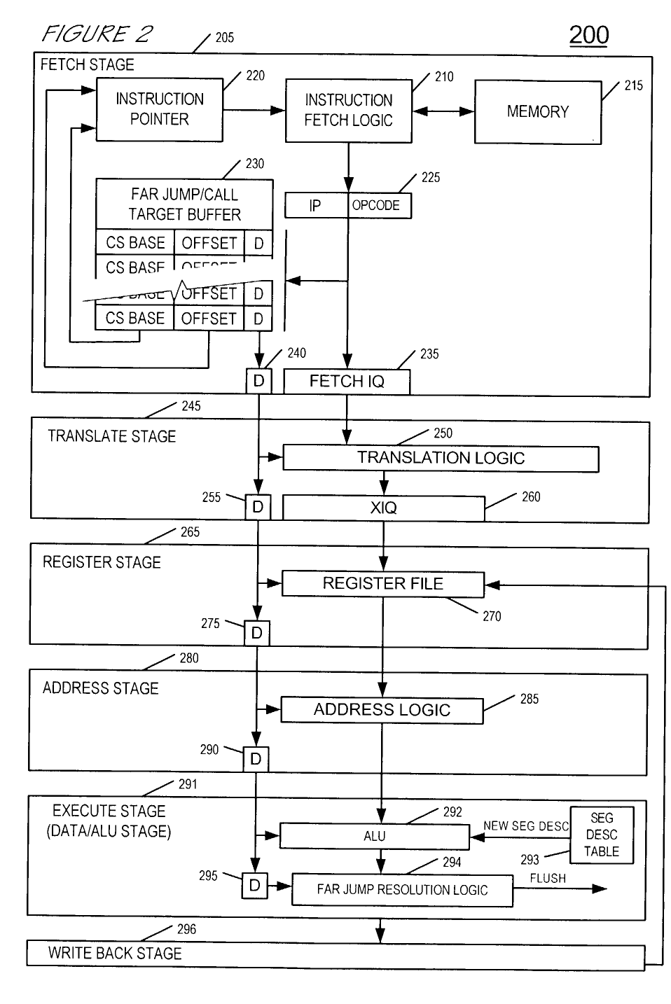

To provide more detail, FIG. 2 is a block diagram of a microprocessor 200 which speculatively executes far jumps/calls in the manner described above to significantly increase pipeline efficiency. Microprocessor 200 includes a fetch stage 205. Fetch stage 205 includes instruction fetch logic 210 which fetches macro instructions from a memory 215 coupled thereto. In more detail, an instruction pointer 220 is coupled to instruction fetch logic 210 to inform instruction fetch logic 210 of the next memory location from which an instruction should be fetched. The instruction thus fetched is denoted as instruction 225 which includes an op code and the instruction pointer (IP) corresponding to the instruction. Instruction 225 is supplied to both Far Jump/Call Target Buffer 230 and Fetch Instruction Queue (Fetch IQ) 235 as shown. Far jump/call target buffer 230 is a branch target buffer (BTB) which includes not only the CS Base (code segment base address) and Offset information for branches which have been executed by microprocessor 200 in the past, but also includes the D bits (default address/operand size bits) for these instructions. The D bits indicate the default address/operand size associated with the segment for these instructions, respectively. In other words, when a far jump/call instruction is resolved, the target address (i.e. the CS Base and the Offset) is provided to the far jump/call target buffer 230 along with the corresponding D bit for update. In this manner, microprocessor 200 updates the far jump/call target buffer 230 with the effective target address and address/operand size base upon the last execution of a particular branch (e.g. far jump or far call) instruction was executed. As will be described in more detail later, microprocessor 200 subsequently tests to see if the D bit associated with a current branch instruction (far jump/call) once actually resolved is the same as that predicted, where the predicted D bit for the current branch instruction is retrieved from a corresponding entry in the far jump target buffer 230. If the resolved state of the D bit is the same as that predicted by the corresponding entry in the far jump target buffer 230, then the default address/operand size for operations on instructions fetched from the target address is the same as that predicted and the pipeline is not flushed. However, if the resolved state for the D bit of the current far jump/call and its state predicted by the D bit of the corresponding entry stored in buffer 230 are not the same, then the pipeline is flushed. In an alternative embodiment, near jump/call information could also be stored in buffer 230 in addition to the far jump/call information described above. Such an arrangement provides for branch prediction of near jump/call instructions.

Far Jump/Call Target Buffer 230 is coupled to instruction pointer 220. In this manner the CS base and Offset associated with particular far jump/call branch instructions are provided to the instruction pointer 220 to enable fetching of designated targets. The D bit associated with instruction pointers and opcodes 225 reaching Fetch Instruction Queue (IQ) 235 is provided to subsequent stages in the pipeline as indicated at D bit 240 in FIG. 2.

The Fetch IQ 235 and D bit 240 are coupled to translate stage 245 as shown in FIG. 2. More particularly, Fetch IQ 235 is coupled to translation logic 250. D Bit 240 is coupled to translation logic 250 and is fed to the next stage as indicated at D bit 255. Translation logic 250 translates each fetched macro instruction provided thereto by Fetch IQ 235 into associated micro instructions which carry out the function indicated by the macro instruction. The translated micro instructions are provided to Translate Instruction Queue (XIQ) 260 along with their corresponding D bits via D bit register 255.

From XIQ 260 the micro instructions are fed to register stage 265. Register stage 265 retrieves operands specified by micro instructions from a register file 270 for use by later stages in the pipeline. Register operands are retrieved from the register file 270 according to the state of the provided D bit. In a manner similar to translate stage 245, the D bit associated with each instruction is passed forward to the D bit output 275 of register stage 265.

Register stage 265 is coupled forward to address stage 280 as shown in FIG. 2. Address stage 280 includes address logic 285 which calculates memory addresses specified by the micro instructions received from register stage 265, and using address calculations according to the address size prescribed by the provided D bit. Again, the D bit is fed forward to the subsequent stage as indicated by D bit 290.

Address stage 280 is coupled forward to execute stage 291 which is also called the data/ALU stage 291. Execute stage 291 performs arithmetic logic unit (ALU) operations on data retrieved from the register file 270 or reads/writes data from/to memory using the memory address calculated in address stage 280. Execute stage 291 includes arithmetic logic unit (ALU) 292 which is coupled to segment descriptor table 293 as shown. The ALU 292 retrieves new segment descriptors from the segment descriptor table 293 when a far jump/call instruction is executed. The new data segment descriptor includes a D bit for the far jump/call instruction currently being executed, namely the actual D bit. Far jump resolution logic 294 compares the retrieved actual D bit of a far jump/call instruction currently being executed with the carried forward predicted D bit 295 from far jump target buffer 230 to determine if the default address/operand size prediction was correct. If the state of the retrieved actual D bit does not match the predicted D bit state 295, then the pipeline is flushed by appropriately asserting the FLUSH signal of far jump resolution logic 294. However, if the state of the retrieved actual D bit matches the predicted D bit state 295, then the pipeline is not flushed.

A write back stage 296 is coupled to execute stage 291 as shown. Write back stage 296 writes the result of a data read operation, or an ALU operation, to register file 270.

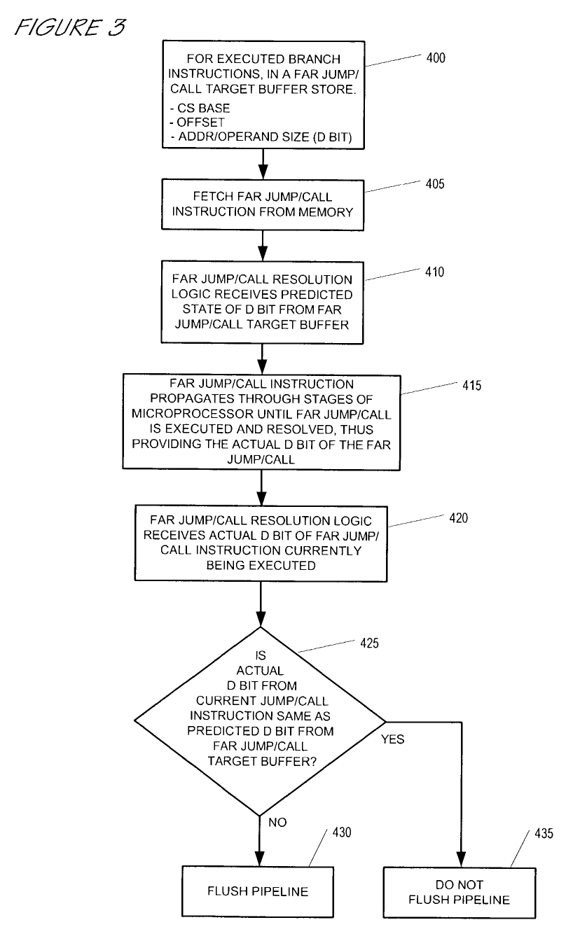

FIG. 3 is a flow chart showing the process flow of instructions through the stages of the microprocessor including the far jump/call resolution logic 294 in execute stage 291. As discussed earlier, a far jump/call target buffer stores the CS base, offset and address/operand size information (D bit) of previously executed far jump/call branch instructions as per block 400. Far jump/call instructions continue to be fetched from memory as indicated in block 405. As per block 410, when a far jump/call instruction is encountered, far jump/call target buffer 230 sends the corresponding D bit to far jump resolution logic 294. This D bit is a speculative or predicted D bit. The far jump/call instruction continues to propagate through the stages of the microprocessor until it is executed and resolved as per block 415. The actual D bit for the far jump/call instruction is thus determined. Far jump/call resolution logic 294 receives the actual D bit of the far jump/call branch instruction currently executed down the pipeline as indicated in block 420. Far jump/call resolution logic 294 also receives the predicted state of the D bit from the far jump/call target buffer 230 as indicated earlier. Far jump resolution logic 294 then compares the two D bits at decision block 425. If the two D bits are different, indicating a change in the default address/operand size, then the pipeline is flushed as per block 430. However, if the two D bits are the same, then a change in address/operand size has not occurred in the current far jump/call branch and the pipeline is not flushed as per block 435. Significant execution time is thus saved by not flushing the pipeline of microprocessor 200.

The above description with reference to FIGS. 2-3 has illustrated an apparatus and a method for providing a processor with a branch prediction mechanism for far jump and far call instructions. The described embodiment eliminates penalties associated with the execution of far jump/call instructions. Moreover, storage of the D bit in a far jump branch target buffer entry significantly reduces the number of incorrect branch predictions associated with far jump/call instructions. Although the present invention and its objects, features, and advantages have been described in detail, other embodiments are encompassed by the invention. In addition to implementations of the invention using hardware, the invention can be embodied in computer readable program code (e.g., software) disposed, for example, in a computer usable (e.g., readable) medium configured to store the code. The code causes the enablement of the functions, fabrication, modeling, simulation and/or testing, of the invention disclosed herein. For example, this can be accomplished through the use of computer readable program code in the form of general programming languages (e.g., C, C++, etc.), GDSII, hardware description languages (HDL) including Verilog HDL, VHDL, AHDL (Altera Hardware Description Language) and so on, or other databases, programming and/or circuit (i.e., schematic) capture tools available in the art. The code can be disposed in any known computer usable medium including semiconductor memory, magnetic disk, optical disc (e.g., CD-ROM, DVD-ROM, etc.) and as a computer data signal embodied in a computer usable (e.g., readable) transmission medium (e.g., carrier wave or any other medium including digital, optical or analog-based medium). As such, the code can be transmitted over communication networks including the Internet and intranets. It is understood that the functions accomplished and/or structure provided by the invention as described above can be represented in a processor that is embodied in code (e.g., HDL, GDSII, etc.) and may be transformed to hardware as part of the production of integrated circuits. Also, the invention may be embodied as a combination of hardware and code.

Moreover, although the present invention has been described with reference to particular apparatus and method, other alternative embodiments may used without departing from the scope of the invention.

Finally, those skilled in the art should appreciate that they can readily use the disclosed conception and specific embodiments as a basis for designing or modifying other structures for carrying out the same purposes of the present invention without departing from the spirit and scope of the invention as defined by the appended claims.

1. A microprocessor for executing a far jump-call instructions, the microprocessor comprising:
a far jump-call target buffer for storing a plurality of default address/operand sizes each corresponding to each of a plurality of previously executed far jump-call instructions; and
instruction fetch logic, coupled to said far jump-call target buffer, for fetching the far jump-call instruction thus providing a fetched far jump-call instruction;
wherein said far jump-call target buffer provides one of said plurality of default address/operand sizes corresponding to the fetched far jump-call instruction.

2. The microprocessor as recited in claim 1, wherein the microprocessor speculatively executes said fetched far jump-call instruction employing said one of said plurality of default address/operand sizes.

3. The microprocessor as recited in claim 2, further comprising:
execution logic, for executing said fetched far jump-call instruction employing said one of said plurality of speculative default address/operand sizes.

4. The microprocessor as recited in claim 3, wherein said execution logic resolves said fetched far jump-call instruction to provide an actual address/operand size.

5. The microprocessor as recited in claim 4, wherein said execution logic comprises:
far jump resolution logic for comparing said actual address/operand size with said one of said plurality of speculative default address/operand sizes.

6. The microprocessor as recited in claim 5, wherein said far jump resolution logic asserts a flush signal directing the microprocessor to flush its pipeline if said actual address/operand size is not the same as said one of said plurality of speculative default address/operand sizes.

7. (canceled)

8. The microprocessor as recited in claim 1, wherein said plurality of default address/operand sizes are associated with corresponding D bits within an x86-compatible microprocessor.

9. (canceled)

10. (canceled)

11. A method for speculatively executing far jump-call instructions in a microprocessor, the method comprising:
storing, in a far jump-call target buffer, a plurality of default address/operand sizes each corresponding to each of a plurality of previously executed far jump/call instructions;
fetching the far jump-call instruction; and
retrieving, from the far jump-call target buffer, one of the plurality of default address/operand sizes corresponding to the far jump-call instruction.

12. The method as recited in claim 11, further comprising:
speculatively executing the far jump-call instruction by employing the one of the plurality of default address/operand sizes.

13. The method as recited in claim 11, further comprising:
resolving the far jump-call instruction to provide an actual address/operand size.

14. The method as recited in claim 13, further comprising:
comparing the actual address/operand size with the one of the plurality of default address/operand sizes.

15. The method as recited in claim 14, further comprising:
asserting a flush signal directing the microprocessor to flush its pipeline if the actual address/operand size is not the same as the one of the plurality of default address/operand sizes.

16. (canceled)

17. The method as recited in claim 11, wherein the plurality of default address/operand sizes are associated with corresponding D bits within an x86-compatible microprocessor.

18. (canceled)

19. (canceled)

20. A method for speculatively executing a far jump/call instructions in a microprocessor, the method comprising:
storing, in a far jump-call target buffer, a code segment base, offset, and default address/operand size for each of a plurality of previously executed far jump-call instructions;
speculatively executing the far jump/call instruction according to the code segment base, offset, and default address/operand size stored in the far jump/call target buffer that correspond to the far jump-call instruction; and
resolving the far jump-call instruction to determine if its actual address/operand size is the same as the default address/operand size provided by said speculatively executing.

21. The method as recited in claim 20, wherein the default-address/operand size is associated with a D bit in an x86-compatible microprocessor.

22. (canceled)

23. The method as recited in claim 20, further comprising:
if said resolving determines that the actual address/operand size is not the same as the default address/operand size, asserting a flush signal that directs the microprocessor to flush instruct ions from its pipeline.
